(19) United States
(12) Patent Application Publication
(10) Pub. No.: US 2014/0339982 A1
(43) Pub. Date: Nov. 20, 2014

(54) MODULAR RECHARGABLE HEADLAMP

(71) Applicant: Daniel Joel Freschl, Berkeley, CA (US)

(72) Inventor: Daniel Joel Freschl, Berkeley, CA (US)

(21) Appl. No.: 13/967,655

(22) Filed: Aug. 15, 2013

Related U.S. Application Data
(60) Provisional application No. 61/683,388, filed on Aug. 15, 2012.

(51) Int. Cl. H05B 33/08; F21L 4/08; B60Q 1/04; F21L 4/04; F21V 29/00; F21L 4/00; F21L 4/02

(52) U.S. Cl. CPC H05B 33/0854; F21L 4/005; F21L 4/085; F21L 4/027; F21L 4/045; F21V 29/22; H05B 33/0845; B60Q 1/04; F21Y 2101/02
USPC 315/82; 362/191; 362/183; 362/184; 315/118; 315/291

(57) ABSTRACT

A portable illuminating device is provided. The device has a rechargeable battery that can be re-charged using a wide variety of power sources, making is especially appropriate for use away from conventional power sources. The device can be connected to a wide variety of fittings that allow the device to be attached to users and to other objects. In some arrangements, the device includes a CPU that manages the power voltage and the temperature of the device so that its operation can be optimized.

### CROSS-REFERENCE TO RELATED APPLICATIONS

This application claims priority to U.S. Provisional Patent Application 61/683,388, filed Aug. 15, 2012, which is incorporated by reference herein.

### BACKGROUND OF THE INVENTION

### Field of the Invention

This invention relates generally to a portable illuminating device, and, more specifically, to a modular rechargeable illuminating device.

Portable illuminating devices have been in existence for many years. Although there are many configurations for such devices, the fundamental design is the same. It consists of an illuminating electrical bulb or LED, a battery pack (either rechargeable or primary), and a housing. Some portable illuminating devices also incorporate a mechanical coupling to attach the device to a user or object; these devices are often called headlamps or miners' lamps.

There are several undesirable characteristics of currently-available illuminating devices. As the battery is used, its voltage fades over time, thus providing the bulb or LED with less and less power. As the power decreases the light output of the bulb or LED fades, providing less and less illumination.

Many illuminating devices use only primary batteries, that is, batteries that cannot be recharged. For such devices, batteries are replaced often. This results in the continual cost of new batteries and the creation of battery waste. As many users of such illuminating devices are people who are avid nature lovers, waste creation is an important drawback.

As illuminating devices are often carried in backpacks or pockets, they can be turned on without the user's knowledge. This results in unintended draining of power and yet more frequent need for battery replacement.

When the illuminating devices contain LEDs, there are drawbacks because of overheating. LEDs cannot be driven to full brightness for extended periods of time when overheated. Such overheating can also shorten the lifespan of the LEDs.

For some illuminating devices the actual light-emitting element is on a separate housing that is connected to the body of the device through a hinge mechanism. Thus the light-emitting housing can be moved away from the body of the device to direct the beam to a desired area. Such hinge mechanisms are clumsy and add weight to these devices. The hinges are also a common point of failure, requiring replacement of the device.

For illuminating devices with multiple housings, electrical communications between housings are bulky and easily damaged, causing electrical disconnections.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic illustration that shows an illuminating device, according to an embodiment of the invention.

FIG. 2 is a flowchart that shows the logical operations that can be performed by a CPU in the illuminating device, according to an embodiment of the invention.

FIG. 3 is a schematic illustration that shows how a hinge mechanism can be used to attach a light-emitting element to the housing of an illuminating device, according to an embodiment of the invention.

FIG. 4 is a plot comparing the brightness of an embodiment of the current invention with the brightness of a standard illuminating device.

### SUMMARY

A portable illuminating device is provided. The portable illuminating device has a light-emitting element, a secondary battery in electrical communication with the light-emitting element, and a CPU in electrical communication with at least the secondary battery. The secondary battery may be a lithium-ion or lithium-polymer battery. These elements are contained within a housing. There is at least one attachment point on the housing, to which one or more exterior modular units can be attached mechanically and/or electrically. There may be at least one tactile-switch in electrical communication with the CPU. There may also be a heat sink in thermal communication with the light-emitting element.

In one arrangement, the modular unit is a charging device that can charge the secondary battery, or, alternatively, provide power directly to the light-emitting element. The charging device can be one or more of solar cells, USB chargers, hand generators and ac or dc power supplies. The charging device may be configured to communicate electrically through wireless energy transfer.

In some arrangements, the CPU is configured to communicate electrically with the light-emitting element, the secondary battery, and the (electrical) attachment point(s), and to perform operations based on pre-determined instructions. The CPU may also be configured to modify the pre-determined instructions if directed to by user input.

The CPU may be configured to detect the voltage of the secondary battery and to perform predefined functions based on said voltage. In one example, the CPU responds to the voltage of the secondary battery or a modular unit energy supply in electrical communication with the light-emitting element in order to provide a constant power level to the light-emitting element. The CPU may regulate power to the light-emitting element through the use of pulse width modulation. As discussed above, battery voltage fades naturally over time, thus providing less power to a light-emitting element. As the power decreases the light output of the light-emitting element fades, providing less and less illumination. By regulating battery voltage, the CPU can ensure that the light-emitting element provides constant illumination.

There may also be a thermal sensing device in electrical communication with the light-emitting element and the CPU so that the temperature of the light-emitting element may be communicated to the CPU. Thus, the CPU may also regulate power to the light-emitting element to prevent the light-emitting element from exceeding predetermined temperatures. As discussed above, overheating. LEDs can reduce their brightness and shorten their lives.

There may also be an additional integrated circuit (in addition to the CPU discussed above) in electrical communication with any of the following: the CPU, the secondary battery, the thermal sensing devices, and the electrical attachment point. The additional integrated circuit can perform such functions as sensing the configuration of the modular unit or the conditions of the surrounding environment and sending such information to the primary CPU.

In one arrangement, the light-emitting element has at least one LED, which provides white light. In some arrangements, the illuminating device has a plurality of LEDs wherein each of the LEDs is configured to emit light of a different wavelength. In one arrangement, the light from at least one light-emitting element is directed through a lens configured to bend light into a plurality of viewing angles.

In one arrangement, the housing has a first section and a second section. The light-emitting element, the secondary battery, the attachment point(s), and other elements are distributed between the two sections. The first section and the second section may be joined together at a hinge, and the first section and the second section are configured to move with respect to one another. A heat sink in thermal communication with the light-emitting element is open to the outside environment when the first section and the second sections are in an open position, that is when they are moved away from one another.

In another aspect of the invention, a headlamp is provided. The headlamp has at least one LED, a secondary battery in electrical communication with the LED. There is a CPU in electrical communication with the LED and with the secondary battery. The CPU is configured to adjust the voltage of the secondary battery in order to provide a constant power level to the light-emitting element. The LED, the secondary battery, and the CPU are located in a housing. In one arrangement, the housing also has at least one attachment point that provides mechanical and/or electrical connection between the headlamp and one or more exterior modular units.

### DETAILED DESCRIPTION

A detailed description of one or more embodiments of the invention is provided below along with accompanying figures that illustrate the principles of the invention. The invention is described in connection with such embodiments, but the invention is not limited to any one embodiment. The scope of the invention is limited only by the claims and the invention encompasses numerous alternatives, modifications and equivalents.

Embodiments of the invention are related to a modular portable illuminating device. The term “modular” is used herein to signify that there are self-contained removable elements that can be attached or removed from the primary housing. The self-contained removable elements will herein be referred to as “modular units”. Each modular unit serves a specific function to allow the device to be adapted to better serve an intended use. The modular units may have mechanical and/ electrical functions. The primary unit also contains several features specifically designed to facilitate both mechanical and or electrical integration with modular units.

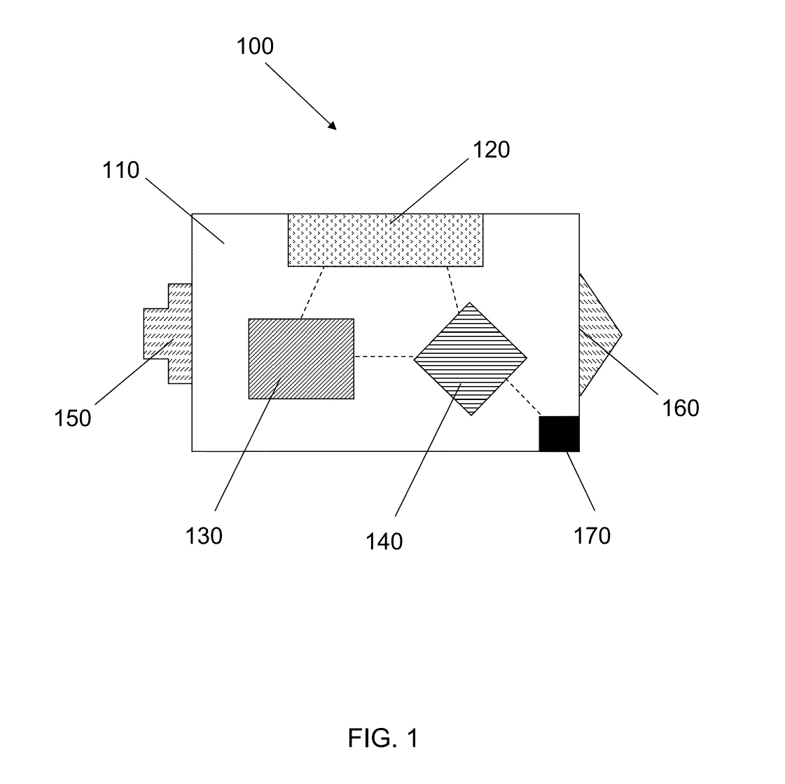

As shown in FIG. 1, a portable illuminating device 100 is provided, according to an embodiment of the invention. The illuminating device 100 has a housing 110 that has a variety of elements. The illuminating device 100 has a light-emitting element 120 configured to provide light external to the device 100. In one arrangement, there is a heat sink (not shown), such as a metal plate, in thermal communication with the light-emitting element 120. The light-emitting element 120 is in electrical communication with a secondary or rechargeable battery 130. The secondary battery 130 (and optionally, the light-emitting element 120) is in electrical communication with a CPU (central processing unit) 140 that is programmed for overall control of the components of the illuminating device 100.

In one arrangement, the illuminating device 100 has a mechanical connector 150 that allows various auxiliary modular units (not shown) to be mechanically attached to the illuminating device 100. In another arrangement, the illuminating device 100 has an electrical connector 160 that allows various auxiliary modular units (not shown) to be electrically attached to the illuminating device 100 and thereby be in electrical communication with circuitry inside the device 100.

In one arrangement, the mechanical connector 150 and the electrical connector 160 are included together in one fitting (not shown). In one arrangement, the illuminating device 100 has a switch 170 with which a user can call upon various functions of the device 100. The switch 170 is in electrical communication with the CPU 140. In one arrangement, the illuminating device 100 has a second integrated circuit (IC) (not shown) that is in electrical communication with the secondary battery 130 and is also in communication with at least one of the CPU 140, the electrical connector 160, the light-emitting element 120, a temperature sensing device (not shown), and the switch 170. The second integrated circuit can perform such functions as sensing the configuration of the modular unit or the conditions of the surrounding environment and sending such information to the primary CPU 140. The CPU 140 can use the information in applying control instructions to the device 100. In one arrangement, the illuminating device has a second switch (not shown) that is in electrical communication with the CPU. Collectively, the light-emitting element 120, the secondary battery 130, the CPU 140, the fittings 150, 160, and the switch 170 will be referred to herein as the components of the illuminating device 100.

In one arrangement, the modular unit has a ridged member such as a bracket or clamp. In another arrangement, the modular unit has a flexible member such as a strap. In yet another arrangement, the modular unit has an elastic member such as an elastic band, rubber, or silicone. Such members make it possible to attach the modular unit to an object or user.

The light-emitting element 120 can contain one or more bulbs and/or LEDs. The light-emitting element 120 can be one or more of a conventional light bulb, such as an incandescent or fluorescent bulb, a halogen bulb or a light-emitting diode (LED). In one arrangement, the bulbs and/or LEDs are all the same color. In another arrangement, the one or more bulbs/LEDs emit light of different wavelengths (colors). Specific bulbs/LEDs can be used to provide illumination in various specialized conditions. In one arrangement, there are one or more lenses configured to bend light from bulbs/LEDs into a plurality of viewing angles. Each bulb or LED may be controlled individually by the CPU 140. In another arrangement, the bulbs and/or LEDs are controlled as one unit by the CPU 140. In one arrangement, one or more of the bulbs/LEDs is configured to signal information about the status of the overall illuminating device 100.

The secondary battery 130 can be any rechargeable battery as is known or may be known in the art. Examples of such batteries include, but are not limited to, lithium, lithium ion and nickel metal hydride batteries. The secondary battery 130 can be charged from any of a plurality of power sources. Examples of such sources include, but are not limited to, primary batteries, external rechargeable batteries, solar cells, wind generators, conventional ac power sources, and car chargers. Power sources to be used for recharging the secondary battery 130 can be put into electrical communication with the secondary battery 130 through any of a variety of connections. Examples of such connections include, but are not limited to, electrical contacts located in the electrical connector 160, USB fittings, micro-USB fittings, any standardized power connection and any wireless charging mechanism capable of transmitting electrical power through non-conductive medium including but not limited to inductive charging.

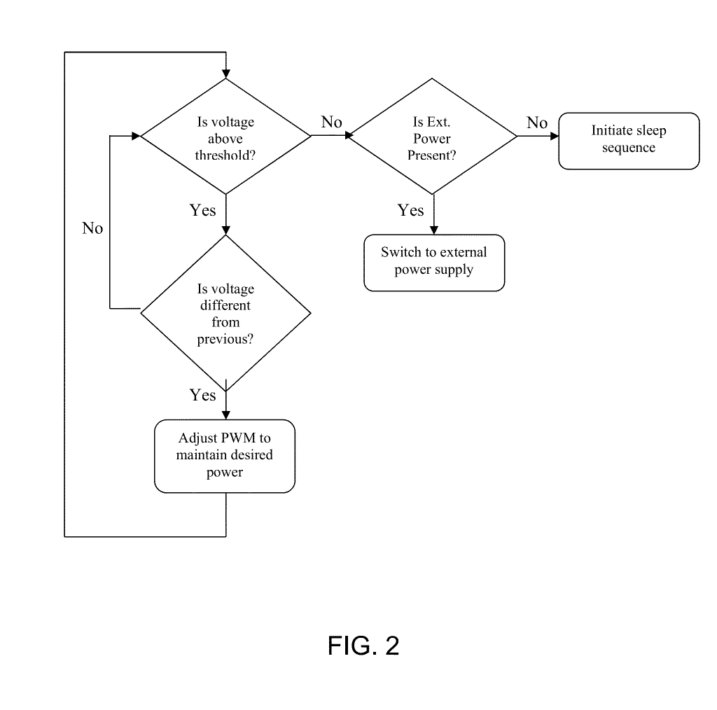

The CPU 140 is programmed to activate and deactivate various electrical connections among the components of the illuminating device 100 based on data the CPU 140 collects from the components of the device 100, according to an embodiment of the invention. FIG. 2 is a schematic diagram that shows the logic used by the CPU in one embodiment of the invention. In one embodiment of the invention, the CPU 140 performs checks on the secondary battery 130 voltage at pre-defined time intervals. In some arrangements, the CPU 140 checks the secondary battery 130 voltage at pre-defined time intervals or continuously. The CPU 140 can perform mathematical calculations using the detected battery voltage to determine how to regulate the power so that the connected light-emitting elements 120 receive the power at a constant level. One method of providing a constant power level to the light-emitting element 120 is through the use of pulse width modulation (PWM) in which the duty cycle (or percentage of time that electricity is flowing to the light-emitting element 120) changes as battery voltage changes. If the CPU 140 detects a battery voltage outside of a prescribed acceptable voltage range the CPU 140 can check for the presence of external power supplies by sensing a voltage on the electrical connector 160. If an external power supply is detected, the CPU 140 can create electrical connections that bypass the secondary battery 130 and power the illuminating device 100 from the external power supply. If no external power supply is detected the CPU 140 can initiate a shut-down (sleep) sequence to prevent operation in undesired conditions. In another arrangement, if the battery voltage is higher than is acceptable, the CPU 140 can disconnect electrical contact between the secondary battery 130 and external power sources that are attempting to charge the battery. In certain arrangements, the CPU 140 can create electrical contact between the secondary battery and electrical elements (not shown) that drain power from the secondary battery until the voltage is within prescribed the acceptable limits. Electrical elements that drain capacity may include but are not limited to resistors, power resistors, light-emitting elements.

In yet another arrangement, the CPU 140 can illuminate one or more bulbs/LEDs in the light-emitting element 120 to indicate the status of the illuminating device 100 to the user. An example of such an indicator is the flashing of one bulb/LED to indicate that the secondary battery 130 power is low. Other conditions that the CPU 140 can detect and indicate to the user may include but are not limited to the following: the CPU is preparing to turn the device off, the illuminator is being switched to an alternative power supply, the secondary battery voltage is outside of prescribed acceptable limits, the user should begin charging the battery to get above minimum voltage, the user should drain the battery to get below maximum voltage, the secondary battery is being charged, the secondary battery has finished charging.

In one embodiment of the invention, the CPU looks for and automatically switches to an alternate power supply (if available) when the secondary battery 130 reaches a predefined state of charge. Alternate power supplies come from the list that includes but is not limited to: primary batteries, external rechargeable batteries, solar cells, wind generators, ac power cords, car-chargers.

In one embodiment of the invention, the user can choose manually between the secondary battery 130 and an alternate power supply. The user may communicate the desire to switch to an alternate power supply through the use of the switch 170, a secondary switch (not shown) internal to the housing 100 or a secondary switch (not shown) external to the housing 100.

In one embodiment of the invention the CPU 140 is programmed to drive light emitting elements with regulated power. Under prescribed conditions, the CPU increases the power to the light-emitting element 120 to the maximum power rating for the light-emitting element 120 for a pre-programmed period of time. In another arrangement, the CPU increases the power to the light-emitting element 120 to somewhere between normal operating power and the maximum power rating for the light-emitting element 120 for a pre-programmed period of time. Increased power results in increased illumination. But, of course, the secondary battery 130 is drained more quickly at increased power.

In another embodiment of the invention, the CPU 140 is in electrical communication with a temperature-sensing device (not shown) that measures the temperature of the light-emitting element 120. The CPU 140 can modulate the power supplied to the light-emitting element 120 in order to provide maximum light without allowing the light-emitting element 120 to reach unsafe temperatures. Unsafe temperatures may be defined as temperature that either limit the life-span of the light-emitting element or may cause harm to the user.

In another embodiment of the invention, the CPU 140 regulates current and voltage that are applied to the secondary battery during charging from external power sources. Such regulation makes it possible to charge the secondary battery 130 from a wide variety of sources, as discussed above. Such regulation also makes it possible to charge the secondary battery 130 from sources that, when un-regulated, provide a voltage or current that is too high or too low to charge the secondary battery safely.

In another embodiment of the invention, the CPU 140 monitors the temperature of the secondary battery 130 and compares the temperature to a prescribed acceptable range of temperature. When the temperature of the battery is too high or too low to permit safe charging of the secondary battery the CPU may prevent charging and may also provide a visual indicator to the user.

In one embodiment of the invention, the illuminating device 100 is configured to communicate with various auxiliary modular units. In one arrangement, there are mechanical modular units. A mechanical unit can connect to the housing 110 of the illuminating device 100 through the mechanical connection 150. There can be more than one mechanical connection

150. In one arrangement, the mechanical modular unit is a strap that can be used to attach the illuminating device 100 to a user's body, such as for use as a headlamp or to a leg or an arm. In another arrangement, the mechanical modular unit has a fitting that can be used to attach the illuminating device 100 to a helmet, a vehicle or a structure. A person of ordinary skill in the art can understand readily that specialized fittings can be made to attach the illuminating device 100 to any desirable member.

In another arrangement, there are electrical modular units. A modular electrical unit can connect to the housing 110 of the illuminating device 100 through the electrical connection 160. In another arrangement, the electrical unit is a power source used to recharge the secondary battery 130. In yet another arrangement, the electrical unit is a power source used to provide power directly to the light emitting element when the built in secondary battery is low on power. Examples of such power sources include, but are not limited to primary batteries, external rechargeable batteries, solar cells, wind generators, conventional ac power sources, and car chargers. In another arrangement, the modular electrical unit is a power source that can be used to provide electrical power to the light emitting element 120.

In one embodiment of the invention, the mechanical connection 150 and the electrical connection 160 are within one fitting (not shown) on the illuminating device 100. A modular unit that includes both a mechanical element and an electrical element can thus have one point of contact to the illuminating device 100. In one arrangement, such a modular unit is a flexible, electrically-conductive member that can be used both to attach the illuminating device 100 to an object or user and to provide electrical communication within one unit. Such a member can be configured to provide a retracting force that assists in mechanical attachment. In another arrangement, such a member can also be configured to include a hand generator. Stretching and releasing the member can generate electricity within the generator, and the electrically-conductive portion of the member can provide a path through which the generated electricity can recharge the secondary battery 130.

In one embodiment of the invention, a tactile switch 170 is in electrical communication with the CPU 140. In one arrangement there is a second tactile switch (not shown) in communication with the CPU 140. In one arrangement, there are prescribed codes through which the switch 170 can communicate with the CPU. In an exemplary embodiment, double clicking of the switch 170 turns on the illuminating device 100, single clicking of the switch 170 cycle through illumination modes previously programmed into the CPU, and holding the switch 170 for an extended period turns off the unit. Other switch manipulations can direct the CPU to display information about the state of the illuminating device 100, such as level of charge in the secondary battery 130. This information can be communicated to the user through specified lighting functions (e.g., flashing) of the light-emitting element 120. As a person of ordinary skill in the art will readily understand, any number of functions can be programmed into the CPU and activated through prescribed switch codes.

In another arrangement, electrical communication with the CPU through the switch can be used to reprogram the CPU allowing the user to change the functions of the primary unit. Examples of such functions include, but are not limited to brightness, working limits of voltage and temperature, combinations of electrical connections between the CPU and light emitting elements, parameters controlling the user interface.

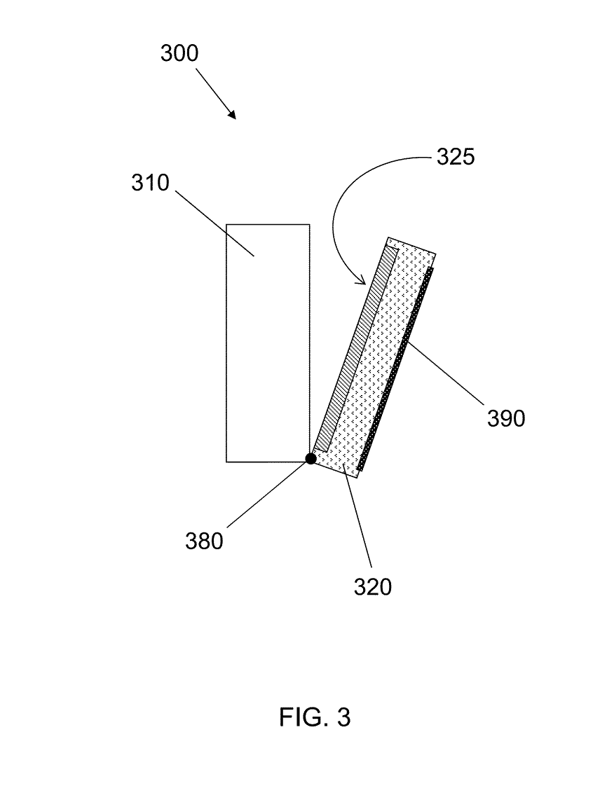

FIG. 3 is a schematic cross-section illustration that shows an illuminating device 300, according to another embodiment of the invention. A light-emitting element 320 is connected to a housing 310 of the illuminating device 300 through a hinge 380. The housing 310 contains some or all of the other elements of the illuminating device 300 and described above for FIG. 1, and there is electrical communication between the housing 310 and the light-emitting element 320. There may be a heat sink 325 in thermal communication with the light-emitting element 320. The light-emitting element 320 can be tilted away from the housing 310 as desired by the user. When tilted away from the housing 310, the heat sink 325 is exposed to the surrounding environment, allowing it to dissipate heat produced by the light-emitting element 320. In addition, the hinge 380 allows the user to tilt the light-emitting element 320 to direct its light in various directions.

As shown in FIG. 3, there is also an optional cosmetic insert 390 that can be used with the illuminating device 100. The light-emitting element 320 has a fitting (not shown) to which such a cosmetic insert 390 can attach. Such inserts 390 can be from any suitable material, such as wood, plastic, metal, glass, stone. Such inserts 390 can also be used with the embodiment of the illuminating device 100 shown in FIG. 1.

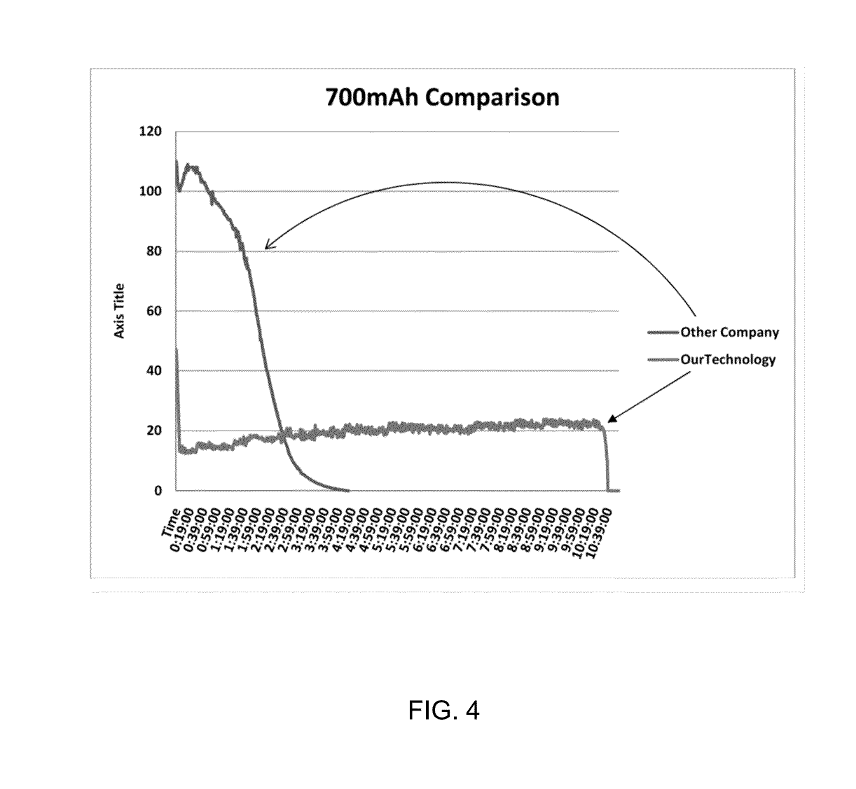

FIG. 4 is a plot comparing the brightness of an exemplary headlamp as described herein with the brightness of a standard illuminating device as a function of time. It can be seen that over time the brightness of a standard illuminating device drops precipitously as battery voltage drops. It can also be seen that a standard illuminating device does not regulate power supplied to the light-emitting element and may allow the light-emitting element to get very hot. Elevated temperatures may reduce the functioning lifespan of light-emitting elements. FIG. 4 also depicts the brightness of an illuminating device, according to an embodiment of the current invention. It can be seen that the brightness approximates a flat line as the CPU monitors battery voltage and attempts to provide the light-emitting element with a constant level of power. It can also be seen that at the end of the test the brightness shuts off digitally as opposed to slowly decaying; this prevents the battery from operating in unsafe low-voltage conditions.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A portable illuminating device, comprising:
a light-emitting element;
a secondary battery in electrical communication with the light-emitting element;
a CPU in electrical communication with at least the secondary battery;
a housing in which the light-emitting element, the secondary battery, and the CPU are located; and
at least one attachment point on the housing, the attachment point providing mechanical and/or electrical connection to one or more exterior modular units.

2. The illuminating device of claim 1 wherein the modular unit comprises a charging device capable of charging the secondary battery and/or providing power to the light-emitting element.

3. The illuminating device of claim 2 wherein the charging device is selected from the group consisting of solar cells, USB chargers, hand generators and ac or dc power supplies.

4. The illuminating device of claim 2 wherein the charging device is configured to communicate electrically through wireless energy transfer.

5. The illuminating device of claim 1 wherein the CPU is configured to communicate electrically with the light-emitting element, the secondary battery, and the (electrical) attachment point(s), and to perform operations based on pre-determined instructions.

6. The illuminating device of claim 5 wherein the CPU is configured to detect the voltage of the secondary battery and to perform predefined functions based on said voltage.

7. The illuminating device of claim 5 further comprising a thermal sensing device in electrical communication with the light-emitting element and the CPU.

8. The illuminating device of claim 5, further comprising an additional integrated circuit (IC) in electrical communication with any of the following: the CPU, the secondary battery, the thermal sensing device, and the electrical attachment point.

9. The illuminating device of claim 5 wherein the CPU adjusts the voltage of the secondary battery or modular unit in electrical communication with the light-emitting element in order to provide a constant power level to the light-emitting element.

10. The illuminating device of claim 5 wherein the CPU regulates power to the light-emitting element to prevent the light-emitting element from exceeding predetermined temperatures.

11. The illuminating device of claim 1 wherein the light-emitting element comprises at least one LED.

12. The illuminating device of claim 11 wherein the LED provides white light.

13. The illuminating device of claim 12, further comprising a plurality of LEDs wherein each of the LEDs is configures to emit light of a different wavelength.

14. The illuminating device of claim 13 wherein the light from at least one light-emitting element is directed through a lens configured to bend light into a plurality of viewing angles

15. The illuminating device of claim 1 wherein the housing comprises a first section and a second section, between which sections the light-emitting element, the secondary battery, the attachment point(s), and other elements are distributed.

16. The illuminating device of claim 15 wherein the first section and the second section are joined together at a hinge, and the first section and the second section are configured to move with respect to one another.

17. The illuminating device of claim 16, further comprising a heat sink in thermal communication with the light-emitting element.

18. The illuminating device of 17 wherein the heat sink is open to the outside environment when the first section and the second sections are in an open position.

19. A headlamp, comprising:
at least one LED;
a secondary battery in electrical communication with the LED;
a CPU in electrical communication with the LED and with the secondary battery, wherein the CPU is configured to adjust voltage of the secondary battery in order to provide a constant power level to the light-emitting element; and
a housing in which the LED, the secondary battery, and the CPU are located.

20. The headlamp of claim 19 wherein the housing further comprises at least one attachment point that provides mechanical and/or electrical connection between the headlamp and one or more exterior modular units.
